(19) United States
(12) Patent Application Publication
(10) Pub. No.: US 2014/0188957 A1
(43) Pub. Date: Jul. 3, 2014

(54) HIERARCHICAL STORAGE SYSTEM AND FILE MANAGEMENT METHOD

(71) Applicant: Hitachi, Ltd., Tokyo (JP)

(72) Inventor: 1. Keita Hosoi, Odawara (JP)

(73) Assignee: HITACHI, LTD., Tokyo (JP)

(21) Appl. No.: 13/819,131

(22) PCT Filed: Nov. 30, 2012
(86) PCT No.: PCT/JP2012/007696

§ 371 Date: Feb. 26, 2013

(51) Int. Cl. G06F 17/30

(52) U.S. Cl. CPC G06F 17/30221
USPC 707/829

(57) ABSTRACT

The present invention makes it possible to execute file management efficiently even if a situation occurs that real data cannot be acquired because metadata in a lower level system cannot be accessed. In a hierarchical storage system, a higher level system acquires available metadata range information indicative of available and unavailable ranges of metadata, from the lower level system, and identifies inaccessible files that are in a state that reading of substantial data in accordance with a stub file is impossible on the lower level, on the basis of the available metadata range information. The higher level system manages this inaccessible file information to transmit the information to a client computer or use the information to control a file access request from the client computer (see FIG. 9).

### TECHNICAL FIELD

The present invention relates to a hierarchical storage system and a file management method, and, for example, relates to a technique for managing unreadable files from a lower level storage subsystem.

### BACKGROUND ART

Recently, a hierarchical storage system has been provided by combining two types of NAS (Network Attached Storage) apparatuses having different characteristics. In this hierarchical storage system, one type I NAS apparatus is used as a higher level storage subsystem, and a group of multiple type II NAS apparatuses as a lower level storage subsystem. The type I NAS apparatus is directly connected to a client computer and directly receives I/O from the client (user). Therefore, the type I NAS apparatus has a characteristic of having good I/O performance. On the other hand, as for the type II NAS apparatuses, though the I/O performance is inferior to that of the type I NAS apparatus, the data storage performance (including, for example, verify/check function) is very superior. In the hierarchical storage system, both of high I/O performance and high data storage performance can be realized by combining these type I and II NAS apparatuses. Such a hierarchical storage system is disclosed, for example, in PTL 1.

In the hierarchical storage system, data satisfying predetermined conditions among data stored in the higher level storage subsystem (for example, in the case where access has not occurred for a predetermined period) is stubbed, and actual data is stored only in the lower level storage subsystem. The data storage structure of the lower level storage subsystem (the type II NAS apparatuses) has a virtual file system layer, a metadata layer and a real data (substantial data) layer. The metadata layer stores metadata (also referred to as metadata corresponding to data) indicative of a correspondence relationship between data in the virtual file system layer and the real data. Primary and secondary copies of this metadata are distributedly stored in the multiple type II NAS apparatuses (also referred to as nodes) so that, even if a node storing the primary copy goes down, the storage system is configured to be able to operate using the metadata of the secondary copy.

### CITATION LIST

### Patent Literature

PTL 1: JP Patent Publication (Kokai) No. 2012-8934A

### SUMMARY OF INVENTION

### Technical Problem

However, in the case where multiple type II NAS apparatuses (nodes) go down and both of primary and secondary copies of metadata become inaccessible or in the case where both of primary and secondary copies of metadata are broken and cannot be read (both cases may be generically referred to as “loss or damage of metadata”), a higher level storage subsystem (the type I NAS apparatus) cannot immediately know whether or not it is possible to actually access real data corresponding to stub data even if attempting to access the real data. In order to ascertain inaccessibility, it is necessary to attempt to execute a reading process for all stubbed data and confirm whether the data can be read or not, in the higher level storage subsystem. This takes a lot of time before unreadability of real data is determined, and is inefficient from the viewpoint of file management. Furthermore, the user cannot know the limit of effects on the job from the breakdown of the node.

The present invention has been made in view of such circumstances and provides a technique for making it possible to, even if such a situation occurs that real data cannot be acquired because metadata in a lower level storage subsystem cannot be accessed, execute file management efficiently.

### Solution to Problem

In order to solve the above problem, the present invention relates to a hierarchical storage system including a first storage subsystem (higher level storage subsystem) receiving an I/O request from a client computer and processing the I/O request and a second storage subsystem (lower level storage subsystem) composed of multiple nodes each of which has a storage apparatus. The second storage subsystem manages metadata indicative of correspondence relationships between multiple files in a virtual space and multiple substantial files in a substantial space corresponding to multiple stub files, respectively. The first storage subsystem manages multiple stub files corresponding to such multiple files that a substantial file exists in the second storage subsystem. The first storage subsystem acquires available metadata range information indicative of available and unavailable ranges of the metadata, from the second storage subsystem, and identifies inaccessible files that are in a state that reading of the substantial data from the second storage subsystem in accordance with the stub file is impossible, on the basis of the available metadata range information. Then, the first storage subsystem manages this inaccessible file information to transmit the information to the client computer or use the information to control a file access request from the client computer.

### Advantageous Effects of Invention

According to the present invention, it becomes possible to, even if metadata is lost or damaged in a lower level storage subsystem, perform file management efficiently.

Further features related to the present invention will be apparent from the description of this specification and accompanying drawings.

### BRIEF DESCRIPTION OF DRAWINGS

FIG. 1 is a diagram showing a schematic configuration of a hierarchical storage system according to an embodiment of the present invention.

FIG. 2 is a diagram showing an example of an internal configuration of a storage apparatus.

FIG. 3 is a diagram showing a configuration example of a stub file.

FIG. 4 is a diagram for illustrating the role of metadata in a lower level storage subsystem.

FIG. 5 is a diagram for illustrating a situation improved by applying the present invention, in detail.

FIG. 6A is a diagram showing a configuration example of a metadata (metadata corresponding to data) DB range state management table 610.

FIG. 6B is a diagram showing a configuration example of the-number-of-available-metadata-DB-ranges management table 620.

FIG. 6C is a diagram showing a configuration example of a file storage destination management table 630.

FIG. 6D is a diagram showing a configuration example of a table for data analysis 640.

FIG. 7 is a flowchart for illustrating a process (the whole outline) according to the embodiment of the present invention.

FIG. 8 is a flowchart for illustrating the details of an available metadata range checking process in the embodiment of the present invention.

FIG. 9 is a diagram illustrating a situation of application of a basic function 1 according to the embodiment of the present invention.

FIG. 10 is a diagram for illustrating a basic function 2 of presenting an unreadable file list for each job unit, according to the embodiment of the present invention.

FIG. 11 is a diagram for illustrating an applied function according to the embodiment of the present invention.

FIG. 12 is a diagram for illustrating a variation of the embodiment of the present invention.

### DESCRIPTION OF EMBODIMENTS

An embodiment of the present invention will be described below with reference to accompanying drawings. In the accompanying drawings, functionally the same elements may be displayed with the same number. Though the accompanying drawings show a specific embodiment and implementation examples in accordance with the principle of the present invention, these are for understanding of the present invention and are never to be used to restrictively interpret the present invention.

Though, in this embodiment, the description thereof is made sufficiently in detail enough for one skilled in the art to practice the present invention, other implementations/forms are also possible. It is necessary to understand that modifications in the configurations/structures and replacement among various elements are possible without departing from the scope and spirit of the technical idea of the present invention. All of various elements and combinations thereof described in the embodiment are not necessarily indispensable for solution means of the invention.

Information of the present invention will be described with expressions such as “aaa table” and “aaa list” in the description below. However, the information may be expressed with those other than data structures such as table, list, DB and queue. Therefore, “aaa table”, “aaa list” and the like may be called “aaa information” in order to indicate that they are not dependent on a data structure.

Though expressions such as “identification information,” “identifier,” “name,” “designation” and “ID” are used when the contents of information is described, these can be replaced with one another.

In the description below, a description may be made with “each processing section,” such as a service level judging section and a migration managing section, as a subject. However, since the contents executed by each processing section are executed by a processor as a part or all of a program, the description may be made with the processor as a subject. A part or all of each processing section (program) may be realized by dedicated hardware.

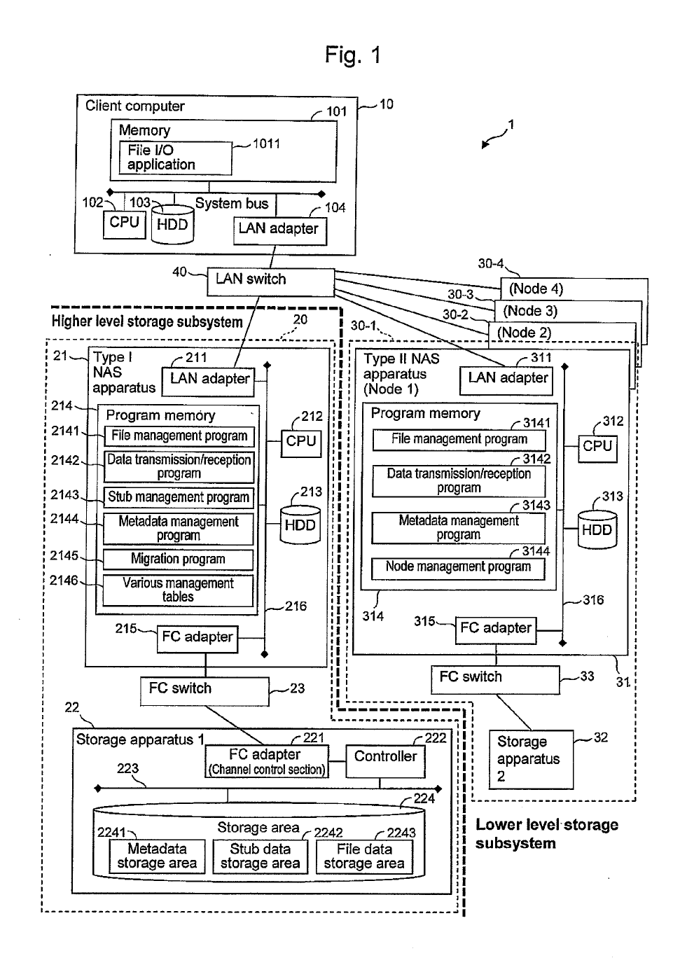

Hereinafter, a set of one or more calculators that manages a calculator system and displays information for display of the present invention may be called a management system. When a management computer displays the information for display, the management computer is the management system. Combination of the management computer and a calculator for display is also a management system. In order to increase the speed and reliability of a management process, a process equal to that of the management computer may be realized by multiple calculators. In this case, the multiple calculators (including the calculator for display if display is performed by the calculator for display) are the management system. As seen by referring to FIG. 1, an apparatus directly corresponding to the management system is not shown in the present invention. However, since a type I NAS apparatus of a higher level storage subsystem has a function of the management system, the type I NAS apparatus may be positioned as the management system.

### <Configuration of Calculator System>

FIG. 1 is a diagram showing a physical schematic configuration of a calculator system (also referred to as a hierarchical storage system) 1 according to the embodiment of the present invention. This calculator system 1 has at least one client computer 10, a higher level storage subsystem 20, a lower level storage subsystem 30 and a LAN switch 40 that executes an operation of sorting requests and data. The lower level storage subsystem 30 has multiple nodes 30-1, . . . , 30-4. Though a configuration example is shown in which four nodes are provided in this embodiment, the number of nodes is not limited to four.

(i) The client computer 10 has a memory 101 storing a file I/O application 1011 that issues a file I/O, a CPU (Central Processing Unit) 102 that executes an application and controls an operation in the client computer, an HDD (Hard Disk Drive) 103 for storing various data, and a LAN (Local Area Network) adapter 104.

(ii) The higher level storage subsystem 20 has a type I NAS apparatus 21, an FC (Fibre Channel) switch 23 and a storage apparatus 1_22.

The type I NAS apparatus has a LAN adapter 211, a CPU 212, an HDD 213, a program memory 214 and an FC adapter 215, and they are connected with one another via a system bus 216.

The program memory 214 stores a file management program 2141 that manages a storage place and the like of each file in the storage apparatus 1_22, a data transmission/reception program 2142 that receives an access request and transmits a response to the request, a stub management program 2143 for stubbing such real data that a predetermined time has elapsed after the previous access, on the basis of the date and time of access to real data, and managing whether stubbing has been performed or not for each file, a metadata management program 2144 for managing metadata (filename, date and time of creation, date and time of access, file size, creator and the like) of each file stored in the storage apparatus 1_22, the metadata being separated from real data, a migration program 2145 for, when data (file) is written, migrating the written data to the lower level storage subsystem 30, and various management tables 2146. Each program is executed by the CPU 212. The details of processing contents of the programs required for the operation of the present invention and the details of the various management tables will be described later.

The storage apparatus 1_22 has an FC adapter 221, a controller 222 and a storage area 224, and these are connected with one another via a system bus 223. The storage area 224 has a metadata storage area 2241 that stores metadata including the filename, date and time of creation, date and time of access, file size, creator and the like of each file, a stub data storage area 2242 that stores stub data (stub files) of stubbed real data, and a file data storage area 2243 that stores real data of files. Real data of stubbed files are not stored in the file data storage area of the storage apparatus 1_22 but stored in storage apparatuses 2_32 of the nodes 30-1 to 30-4 in the lower level storage subsystem. Stub data is link information indicative of a storage place in the storage apparatus 2_32 of the lower level storage subsystem.

(iii) The lower level storage subsystem 30 is composed of the multiple nodes 30-1 to 30-4 as described above. Each of the nodes 30-1 to 30-4 has a type II NAS apparatus 31, the storage apparatus 2_32 and an FC switch 33.

The type II NAS apparatus 31 has a LAN adapter 311, a CPU 312, an HDD 313, a program memory 314 and an FC adapter 315, and these are connected with one another via a system bus 316. The nodes are connected such that they can communicate with one another not via the LAN switch 40 but directly though it is not shown in FIG. 1.

The program memory 314 stores a file management program 3141 that manages the storage place and the like of each file in the storage apparatus 2_32, a data transmission/reception program 3142 that receives a request from the higher level storage subsystem and returns a response thereto, a metadata management program 3143 for creating and managing metadata corresponding to data indicative of spatial correspondence relationship between a virtual file system layer and a real data layer that stores real data of a file migrated from the higher level storage subsystem, and a node management program 3144. Each program is executed by the CPU 312.

From the higher level storage subsystem 20, it appears as if migrated data exists in the virtual file system layer not shown. However, actual data (real data (substantial data)) is stored in the real data layer under a filename different from a filename existing in the virtual file system layer. Since the correspondence relationship between the virtual file system layer and the real data layer is not established in such a situation, metadata (metadata corresponding to data: different from ordinary metadata such as a filename) indicative of the correspondence relationship therebetween is created and stored into a metadata layer. This metadata corresponding to data does not exist in the higher level storage subsystem 20 but exists only in the lower level storage subsystem 30.

The node management program 3144 manages which number node in the lower level storage subsystem 30 its own node is, and, when receiving a read request from the higher level storage subsystem 20, identifies which node a target file exists in by performing communication among nodes. Nodes are switched in turn to receive a read request such that a node 1 receives a request from the upper side during a certain period of time, and a node 2 receives a request from the upper side during another period of time (this is realized by a round robin function of a DNS server). Then, in the node in charge of receiving a request, the node management program 3144 performs multicasting in order to inquire of each node in which node a file targeted by the read request is stored. The node management program 3144 of each node which has received the multicast inquiry replies to the inquiry source node management program 3144 about whether or not its own node stores the data of the target file in a storage area.

Furthermore, the file management program 3141 of a node which has received a write request (migration request) from the higher level storage subsystem 20 may acquire information about the used capacity of the other nodes from the other nodes and communicate with the other nodes to write target data into a node with a largest amount of space. It is also possible to migrate real data which has been originally migrated and written to, for example, the node 1 to another node because the available capacity of the node 1 decreases. Such a process is also executed by the file management program 3141 of each node.

### <Operation of Hierarchical Storage System>

Next, data write and read processes by the calculator system (hierarchical storage system) 1 will be briefly described.

(i) Process at the time of writing data

When writing data with the client computer 10, a user transmits a write request to the type I NAS apparatus 21 first. The type I NAS apparatus 21 receives the write request and writes target data to the storage apparatus 1_22 connected to the type I NAS apparatus 21. The data written to the storage apparatus 1_22 is migrated to the lower level storage subsystem 30 at a predetermined timing (for example, at the time of daily batch processing). At this stage, the target data is still stored in the upper side, and stub data of the data has not been generated. Then, when the frequency of accessing the target data becomes lower than a predetermined value or when access has not occurred for a predetermined period, the data is stubbed, and only stub data is left in the stub data storage area 2242, and the real data is deleted from the file data storage area 2243. Data (real data) accessed with a higher frequency than the predetermined value continues to be stored in the higher level storage subsystem 20.

(ii) Process at the time of reading data

When reading data with the client computer 10, the user transmits a read request to the type I NAS apparatus 21. The type I NAS apparatus 21 which has received the read request confirms whether target real data is stored in the storage apparatus 1_22 first, and, if the real data exists, transmits it to the client computer 10.

If the target data is stubbed, and the real data does not exist in the storage apparatus 1_22, then the type I NAS apparatus 21 makes an inquiry to the type II NAS apparatus 31 of the lower level storage subsystem 30 on the basis of information about the storage place of the real data that is included in a stub file. The type II NAS apparatus 31 acquires real data corresponding to the inquiry and transmits the acquired real data to the type I NAS apparatus 21. The type I NAS apparatus 21 transmits the received real data to the client computer 10 as well as storing the acquired real data in the file data storage area 2243 of the storage apparatus 1_22. This real data is already stubbed. However, there is a possibility of the next access, the real data is temporarily stored on the upper side so as to quickly cope with this situation. Therefore, if the real data stored temporarily is not accessed again for a predetermined time, the real data is deleted from the file data storage area 2243. It is also possible to, when the real data is temporarily acquired from the lower side, delete corresponding stub data, and stub the real data again when access does not occur for a predetermined time.

### <Main Configuration of Storage Apparatus>

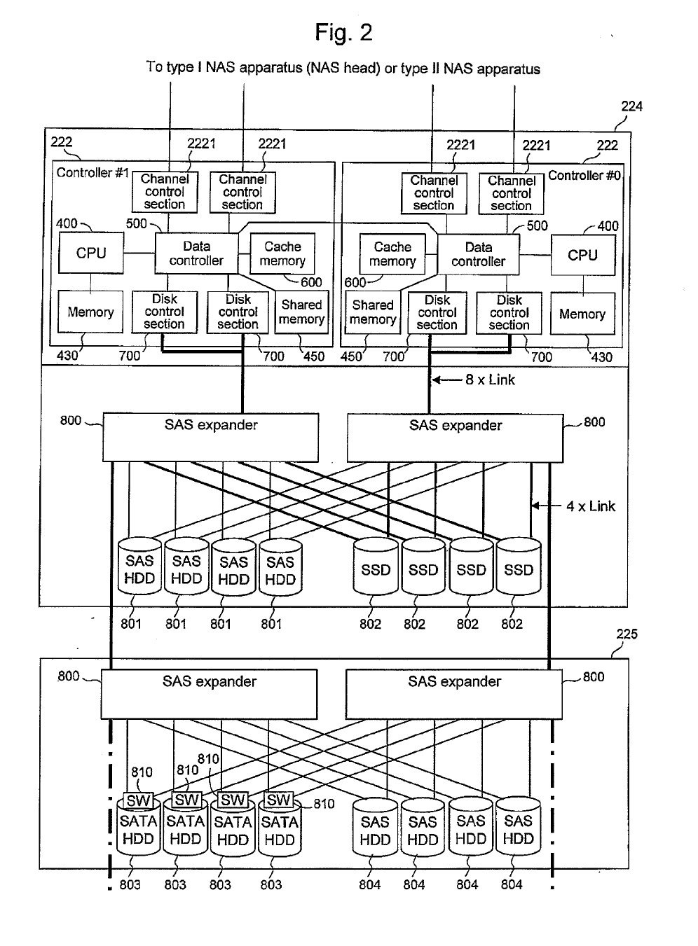

FIG. 2 is a functional block diagram showing a main configuration of the storage apparatus 1_22 or 2_32.

The storage apparatus 1_22 or 2_32 is configured such that each of sections on a data path from the host to HDDs 801 to 804, such as the controller 222 and an SAS expander 800, is doubled. Fail-over in which, even in the case of occurrence of a fault on one path, processing is continued by switching to the other path, load distribution and the like are possible. A storage area 225 is a storage area provided, being added to the storage area 224 in FIG. 1 in parallel.

Each controller 222 and each expander 800 are provided with multiple physical ports and correspond to two systems of port groups A and B. The controllers 222, the expanders 800 and the HDDs 801 to 804 are connected in that order such that redundancy is held among them, by combining the physical ports. In a basic casing 224 of the storage apparatus, two controllers #0 and #1 are connected. Each controller 222 is connected to a first or second storage apparatus at a channel control section 2221. Even in the case of bad connection at one port group, it is possible to continue by switching to connection at the other port group. To each expander 800, all of the multiple HDDs 803 and 804 in an added casing 225 are connected through buses, via the multiple physical ports the expander 800 has.

The expander 800 has a switch for switching among the paths among the physical ports in the expander 800, and the switching is performed according to data transfer destinations.

(iii) The above hierarchical storage subsystem is outlined as follows.

That is, a high-speed and small-capacity NAS apparatus (type I NAS apparatus) is used as the higher level storage subsystem 20.

NAS apparatuses (type II NAS apparatuses) with a lower speed and larger capacity than those of the type I NAS apparatus, which manage stored files, separating the files in real data and metadata (metadata corresponding to data or spatially corresponding metadata), are used as the lower level storage subsystem 30.

The higher level storage subsystem 20 duplicates (migrates) all data accepted from the client computer 10 into the lower level storage subsystem 30.

The higher level storage subsystem 20 continues to hold substantial data only for data accessed with a high frequency, and, as for data accessed with a low frequency, executes a process of leaving only the address on the lower level storage subsystem 30 (virtual file system layer) (stubbing). Then, the higher level storage subsystem 20 operates as a pseudo-cache of the lower level storage subsystem 30.

### <Configuration of Stub File>

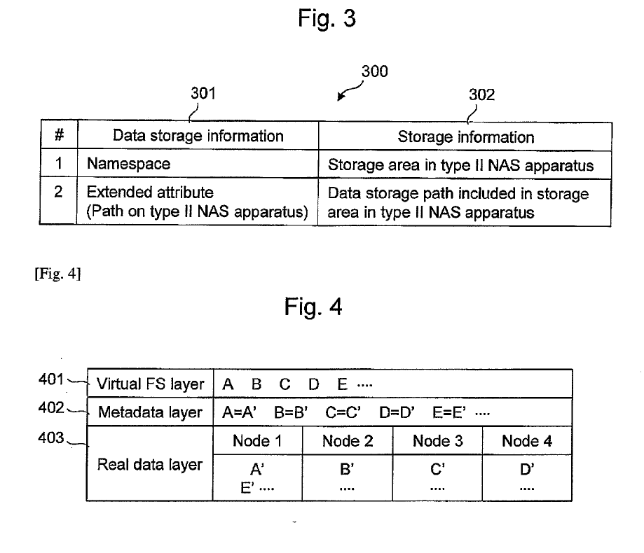

FIG. 3 is a diagram showing a configuration example of a stub file used in the embodiment of the present invention.

A stub file (stub data) 300 is information indicative of where in the virtual file system of the lower level storage subsystem 30 data is stored. No matter what the number of nodes is, there is one virtual file system in the lower level storage subsystem 30, which is common to the nodes.

The stub file 300 has data storage information 301 and storage information 302 as configuration items. The data storage information 301 of the stub file 300 includes a namespace (something like a directory on the virtual file system) 303 and an extended attribute 304. The namespace 303 is information for identifying a storage area within the type II NAS apparatuses. The extended attribute 304 is information indicative of a storage path (a specific storage place on the namespace) of data included in a storage area within the type II NAS apparatuses.

### <Role of Metadata>

FIG. 4 is a diagram showing the role of metadata (referred to as metadata corresponding to data or spatially corresponding metadata) of the lower level storage subsystem 30 in the embodiment of the present invention.

As shown in FIG. 4, in a virtual file system layer 401, files A, B, C, . . . are stored in a storage area shown by a stub file (see FIG. 3). This file A and the like do not indicate actual real data but indicate virtual files in a virtual space.

A real data layer 403 is an area that stores real data corresponding to a stub file, and each real data is distributed and stored in nodes.

A metadata layer stores metadata that shows correspondence relationships between virtual files (A, B, . . . ) in the virtual file system layer 401 and real files (A′, B′, . . . ) in the real data layer 403.

Thus, the metadata corresponding to data shows a correspondence relationship between the virtual file system layer and the real data layer. Therefore, when the metadata is damaged, it becomes impossible to acquire real data from a stub file.

### <Situation Improved by the Present Invention>

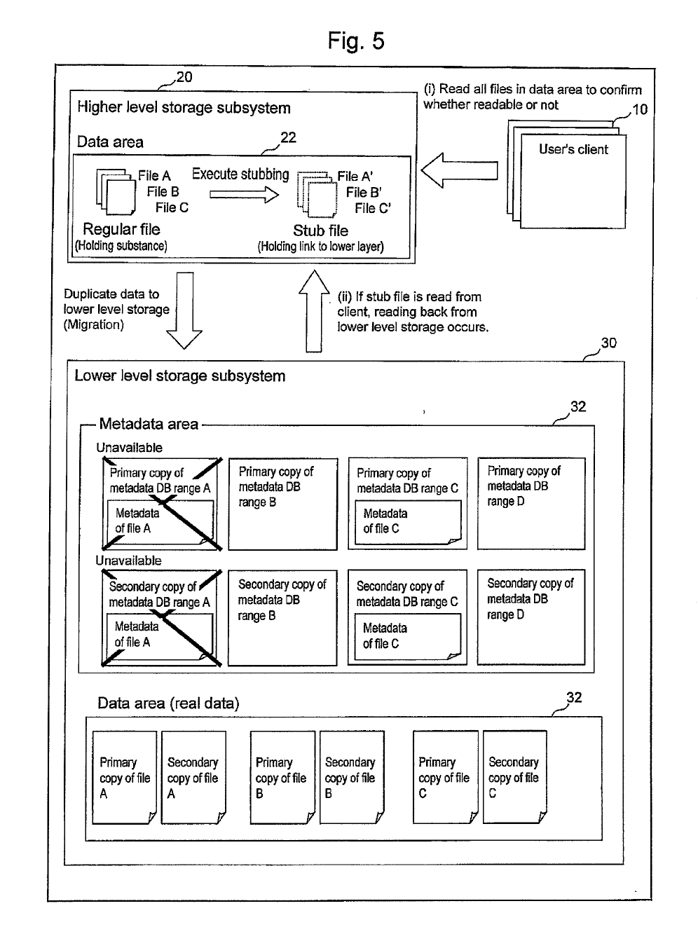

FIG. 5 is a diagram for illustrating a situation improved by applying the present invention, in detail.

In the higher level storage subsystem 20, the files A to C are written from the client computer 10, and, furthermore, duplicated data of the files A to C are migrated to the lower level storage subsystem 30. Primary and secondary copies of the migrated real data are written into a data area (real data layer) of the storage apparatus 2_32 of the lower level storage subsystem 30 (distributed and stored in the nodes). Then, in the higher level storage subsystem 20, the files A to C are stubbed appropriately and stored as stub files A′ to C′. At this time, the substantial data of the files A to C are deleted from the data area of the storage apparatus 1_22 of the higher level storage subsystem, as described before.

After the files are stubbed in the higher level storage subsystem 20, metadata corresponding to data indicative of a corresponding relationship between the real data in the data area (real data layer) and data in the virtual file system is created at a predetermined timing and held in the metadata area (metadata layer) of the storage apparatus 2_32 of the lower level storage subsystem 30. As described before, the higher level storage subsystem 20 accesses the data in the virtual file system layer, and, therefore, it cannot access desired real data if this metadata corresponding to data is not set. Thus, the metadata corresponding to data is metadata for enabling access to real data on the lower side from the upper side, and access to the real data is ensured if the metadata exists (fault tolerance). In order to make this fault tolerance much robuster, primary and secondary copies of the metadata are stored in different nodes in the lower level storage subsystem 30 so that, even if the primary-copy metadata is lost or damaged (a state in which the metadata cannot be read because the node goes down or the metadata itself is broken) in one node, access is realized with the use of the secondary copy.

However, as shown in FIG. 5, for example, if each of the nodes storing the primary and secondary copies of the metadata of the file A fails, or if a part of a metadata area is lost or damaged and the primary and secondary copies of the metadata of the file A are included in the lost or damaged part, it is not possible to read the real data of the file A.

The phenomenon that real data cannot be read can be caused by loss or damage of metadata corresponding to data can be also caused by loss or damage of the real data itself.

On the other hand, when receiving a request to access a file once stubbed, from the client computer 10, the higher level storage subsystem 20 requests the lower level storage subsystem 30 to acquire corresponding real data. However, if corresponding primary and secondary metadata is lost or damaged, the higher level storage subsystem 20 cannot acquire the corresponding real data. The higher level storage subsystem 20, however, cannot immediately judge whether or not the requested real data can be acquired in the end (whether or not the desired real data can be read). This is because the higher level storage subsystem 20 cannot judge whether both of primary and secondary copies of a part of metadata are lost or damaged in the lower level storage subsystem 30 or whether a fail-over process is being performed. If the fail-over process is being performed, the desired real data can be acquired when the process ends. In the case of loss or damage of the primary and secondary metadata, however, the desired real data cannot be acquired. Because it cannot be judged which case has occurred until after elapse of a timeout value (for example, five minutes) of the fail-over process set in the lower level storage subsystem 30, the higher level storage subsystem 20 waits during time corresponding to this timeout value. When the timeout value elapses, the higher level storage subsystem 20 can judge that the cause of having not been able to read the real data is loss or damage of metadata, for the first time. In this case, it is necessary for the higher level storage subsystem 20 to recognize in which range the metadata is completely lost or damaged. Therefore, for all stubbed files, the higher level storage subsystem 20 repeats a read request to the lower level storage subsystem 30 to confirm whether reading is possible or not. Since it takes the time corresponding to the timeout value to judge whether reading of one file is possible or not as described above, time corresponding to the number of stubbed files x the timeout value is required as a total.

Thus, it takes a very enormous amount of time to confirm how wide the range is in which complete loss or damage of metadata (loss or damage of primary and secondary metadata due to down of multiple nodes or the like) has occurred, which is very inefficient from the viewpoint of system operation.

When, for example, four nodes (30-1 to 30-4) are set in the lower level storage subsystem 30 and two of them fail, only the other two nodes which have not failed execute a process though it is originally set that four nodes are to execute the process. Accordingly, the load imposed on these two nodes increases. Therefore, when the operation is continued with the two nodes in such a situation (execution of the process of reading real data corresponding to all the stub files is continued in order to identify the range of loss or damage of the metadata), the two nodes which have not failed may also fail, and complete system stop (secondary disaster) may be brought about. Such a secondary disaster has to be avoided.

Coping with occurrence of a situation as described above, the present invention quickly identifies the range of loss or damage (complete loss or damage) of metadata and avoids occurrence of a secondary disaster.

In the case where real data is damaged also, it is not possible to acquire the real data from a stub file. The lower level storage subsystem 30, however, checks loss or damage of real data periodically to manage availability and unavailability of the real data. Therefore, if reading is impossible due to loss or damage of real data, the lower level storage subsystem 30 can immediately notify the higher level storage subsystem 20 of an error message. Therefore, in comparison with the case where metadata (both of primary and secondary copies) are lost or damaged, the inconvenience does not occur that it takes much time to perform a process at the time of an error and the efficiency decreases.

### <Configuration Examples of Various Management Tables>

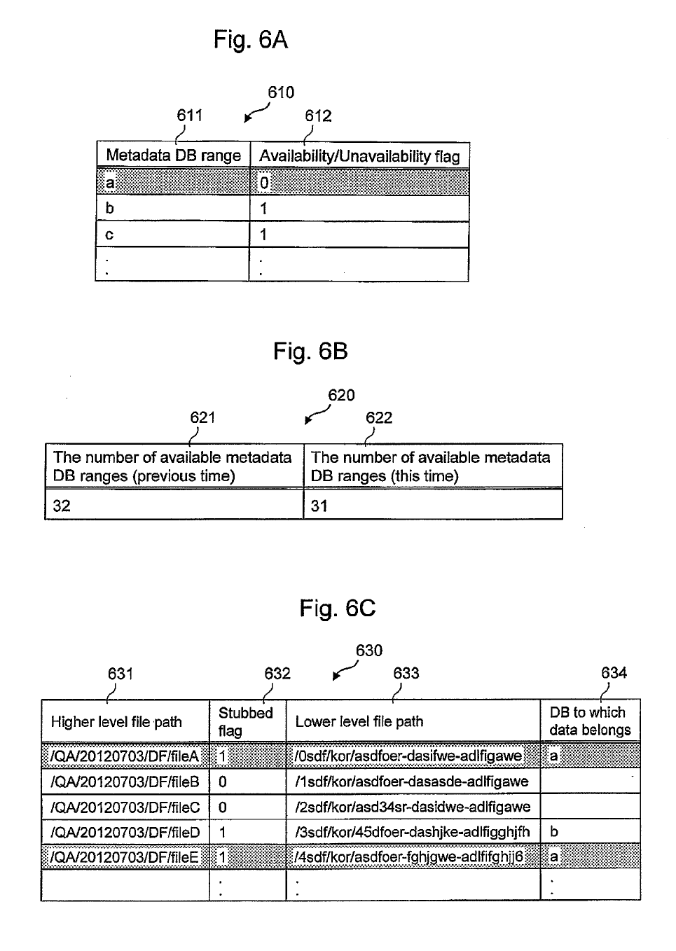

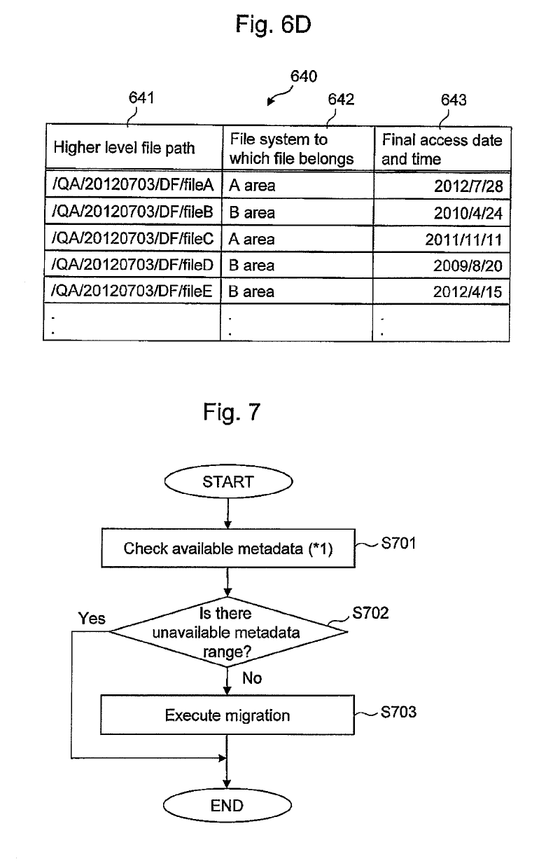

FIGS. 6A to 6D are diagrams showing configuration examples of the various management tables 2146 held by the higher level storage subsystem 20, respectively.

(i) Metadata DB range state management table

FIG. 6A is a diagram showing a configuration example of a metadata (metadata corresponding to data) DB range state management table 610.

The metadata (metadata corresponding to data) DB range state management table 610 is a table for performing management, for each range of a metadata DB in the lower level storage subsystem 30, about whether the corresponding range can be effectively read or whether it cannot be read due to loss or damage by a fault or the like and is unavailable. The metadata (metadata corresponding to data) DB range state management table 610 has metadata DB range 611 and availability/unavailability flag 612 indicating whether a corresponding range is available or unavailable, as configuration items. As described before, in the hierarchical storage system 1, the metadata DB for storing metadata is not concentratedly provided in one node but is divided in multiple parts and distributedly stored in the nodes to improve fault tolerance. For metadata in one range, primary and secondary copies are generated and are stored in different nodes. In this embodiment, the lower level storage subsystem 30 of the hierarchical storage system is composed of four nodes, and each node holds eight metadata areas (metadata DB ranges). Therefore, the number of metadata DB ranges to be managed is 32 (4×8=32).

When an unavailability flag “0” is on as the availability/unavailability flag 612, it is known that metadata in a corresponding range cannot be read because of a fault, and corresponding real data cannot be accessed as a result.

(ii) The-number-of-available-metadata-DB-ranges management table

FIG. 6B is a diagram showing a configuration example of the-number-of-available-metadata-DB-ranges management table 620.

The-number-of-available-metadata-DB-ranges management table 620 has the number of metadata DB ranges n (previous time) 621, which represents the number of ranges judged to be available in the previous process of judging whether each metadata DB range is available or unavailable, and the number of available metadata DB ranges m (this time) 622, which represents the number of ranges judged to be available in the current process, as configuration items.

From FIG. 6B, it is seen that one metadata DB range cannot be read due to some cause. For example, if two nodes fail completely, 16 metadata DB ranges cannot be read, and m=16 is shown.

(iii) File storage destination management table

FIG. 6C is a diagram showing a configuration example of a file storage destination management table 630.

The file storage destination management table 630 has higher level file path 631 indicating a storage destination of a file in the higher level storage subsystem 20, stubbed flag 632 indicating whether a corresponding file has been already stubbed or not, lower level file path 633 indicating a storage destination (virtual file system) of a corresponding file in the lower level storage subsystem 30, and DB to which data belongs 634 indicating a metadata DB range in which metadata required to acquire corresponding real data when a file is stubbed is included, as configuration items.

In the field of DB to which data belongs 634, a result of a calculation (to be described later) for, when a file is stubbed, determining the metadata location in the lower level storage subsystem 30 of the stubbed file is to be inputted. Accordingly, even if a file is stubbed, the field is empty unless the calculation is executed.

(iv) Table for data analysis

FIG. 6D is a diagram showing a configuration example of a table for data analysis 640.

The table for data analysis 640 has higher level file path 641 indicating a storage destination of a file in the higher level storage subsystem 20, file system to which file belongs 642 indicating a file system area in the storage area 224 of a corresponding file, and final access date and time 643 indicating the final access date and time of a corresponding file, as configuration items.

This table for data analysis 640 is used for analysis of an unreadable file. That is, if an unreadable file can be identified, it becomes clear in which file system to which file belongs the unreadable file is included by referring to the table for data analysis 640.

For example, assumed is a case of operating the hierarchical storage system 1 using a file system A area as an area for storing a file of the user's X1 job and a file system B area as an area for storing a file of the user's X2 job. Then, it is assumed that, for example, it becomes clear from the file storage destination management table 630 and the metadata DB range state management table 610 that real data corresponding to a file D (already stubbed) cannot be read due to loss or damage of metadata in the lower level storage subsystem 30. At this time, since the file system B to which the file D belongs is related to the job X2, the administrator (user) of the job is notified of a situation arising where the file cannot be read due to loss or damage of the metadata to call his attention. It is also possible to list up files that are inaccessible due to loss or damage of metadata for each job and present the list to the administrator of the job.

<Contents of process>

(i) The whole outline

FIG. 7 is a flowchart for illustrating a process (the whole outline) according to the embodiment of the present invention.

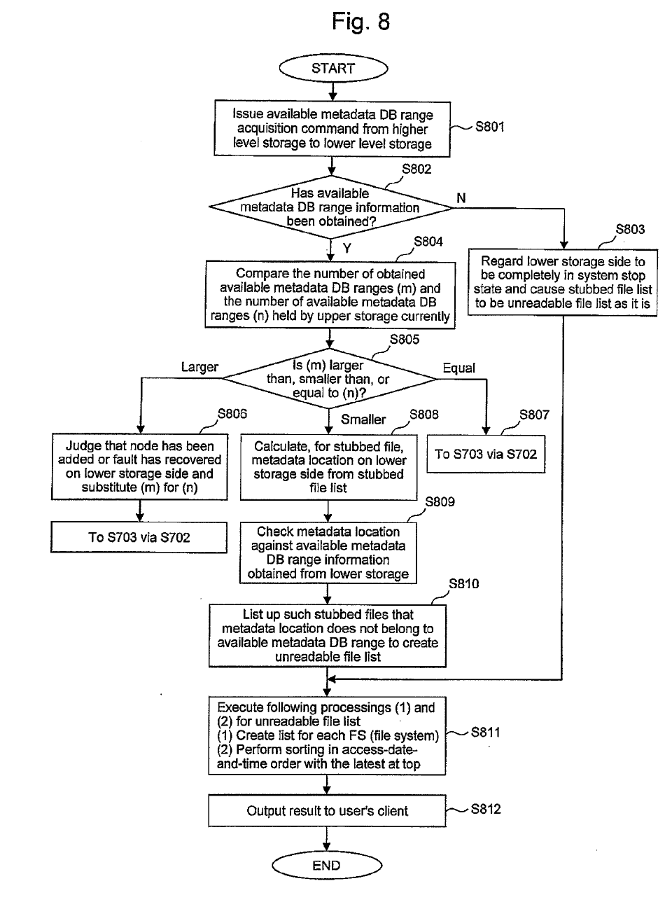

The migration program 2145 of the type I NAS apparatus 21 checks available metadata ranges (available metadata corresponding to data ranges) (S701). Though the available metadata checking process is caused to operate as preprocessing before execution of a migration process in the present embodiment, the process may be caused to operate when an SNMP trap indicating occurrence of a node down event is received from the lower level storage subsystem 30 or may be caused to operate by the user making an instruction appropriately. The details of available metadata checking process will be described later with the use of FIG. 8.

Then, the migration program 2145 judges whether or not an unavailable metadata range exists in available metadata range information acquired by the available metadata checking process of S701 (S702). If there is an unavailable range in the metadata DB range information, the process ends. If there is not an unavailable range, the process proceeds to S703.

Next, the migration program 2145 migrates a duplicate of a file stored in the storage apparatus 1_22 of the higher level storage subsystem 20 to the lower level storage subsystem 30 (S703).

As described above, in the present invention, available metadata ranges are checked before regular migration (migration at the time of data writing). If it is judged that metadata is lost or damaged in the lower level storage subsystem 30, the lower level storage subsystem 30 enters a read-only mode, and the migration process becomes unavailable. Therefore, even if the migration process is executed in such a situation, it will be useless. The case where metadata is lost or damaged in the lower level storage subsystem 30 (a part of ranges are completely unreadable) is a case where at least two nodes have failed. If the migration process is attempted when the number of available nodes is smaller than the original number, the load in the lower level storage subsystem 30 becomes excessive, and there is a risk of leading to a failure of the whole system. Therefore, in order to avoid such a risk also, it is effective to perform the prior process of checking available metadata DB ranges.

In this specification, a flowchart and the like of a response process for I/O from the client computer 10 (an I/O process) are not shown. Since the I/O process is similar to that of an ordinary hierarchical storage system, it is omitted.

(ii) Details of available metadata DB range checking process

FIG. 8 is a flowchart for illustrating the details of the available metadata DB range checking process.

The migration program 2145 issues an available metadata DB range information acquisition command, and transmits the command to the lower level storage subsystem 30 using the data transmission/reception program 2142 (S801). This command is for draws up information about available ranges (available ranges of the metadata DB) of metadata (metadata corresponding to data) held by the lower level storage subsystem 30, from the lower level storage subsystem 30 into the higher level storage subsystem 20.

The migration program 2145 judges whether or not the available metadata DB range information has been acquired according to the command transmitted at S801 (S802). If the available metadata DB range information has not been acquired at all (not even about one range), the process proceeds to S803. If the available metadata DB range information has been acquired about at least one range, the process proceeds to S804. It is assumed that the lower level storage subsystem 30 grasps nodes in which metadata ranges are stored, respectively, and grasps which metadata range cannot be read due to a failure of a node.

At S802, the migration program 2145 judges that all the nodes in the lower level storage subsystem 30 are completely in a stop state (system stop state) and includes all stubbed files into an unreadable file list. Then, the process proceeds to S811.

At S803, the migration program 2145 refers to the-number-of-available-metadata-DB-ranges management table 620 and compares the number of available metadata DB ranges obtained this time (m) and the number of available metadata DB ranges obtained at the previous time (n).

The migration program 2145 causes the process to proceed to S806 if m is larger than n, proceed to S807 if m equals to n, and proceed to S808 if m is smaller than n (S805). If m is smaller than n, execution of the migration process is inhibited.

At S806, in the case of m>n, the migration program 2145 judges that a node has been added, or a failure occurred and then a node has recovered, in the lower level storage subsystem 30, and replaces the value of n with the value of m. Then, the process proceeds to S703 via S702, and the migration process is performed.

At S807, in the case of m=n, the migration program 2145 judges the state to be a steady state, and causes the process to proceed to S703 via S702, and executes the migration process.

At S808, the migration program 2145 calculates the metadata location in the lower level storage subsystem 30 of each stubbed file, from a stubbed file list. As for the location of metadata, for example, the number of the remainder obtained when dividing an output result obtained by inputting a file path of the virtual file system of the lower level storage subsystem 30 into a hash code method (a general method for calculating a hash) of Java (R) by the number of available metadata DB ranges at the time of normal operation of the lower level storage subsystem 30 indicates a metadata DB range to which file belongs. This calculation result is stored in the field of DB to which data belongs 634 in the file storage destination management table 630. It is not necessarily required to provide the field of DB to which data belongs 634 in the file storage destination management table 630. In the case where the field is not provided, however, the above calculation of S808 is performed, for example, for each process of migrating a target file. Accordingly, the calculation becomes overhead, and there is a possibility that the migration process itself is speeded down. Therefore, it is recommended to improve the efficiency of the process by calculating, and inputting into the DB to which data belongs 634, the metadata DB range to which file belongs for each file during such a time period that the calculation does not become overhead.

Next, the migration program 2145 refers to the metadata DB range state management table 610 (FIG. 6A) and compares available metadata DB ranges held by the higher level storage subsystem 20 and available metadata DB ranges acquired from the lower level storage subsystem 30 (S809). Then, the migration program 2145 updates the availability/unavailability flag 612 of each metadata DB range 611 in the metadata DB range state management table 610 (FIG. 6A).

Next, the migration program 2145 identifies stubbed files included in unavailable metadata DB ranges shown by the metadata DB range state management table 610 by referring to the file storage destination management table 630, and lists up such files that data reading is impossible for the reason of loss or damage of metadata (metadata corresponding to data) (an unreadable file list) (S810). More specifically, if metadata of a metadata DB range “a” is unavailable (lost or damaged) as shown in FIG. 6A, the migration program 2145 extracts such higher level file paths that “a” is shown as the DB to which data belongs 634 in the file storage destination management table 630 to identify unreadable files. If the DB to which data belongs 634 is not provided in the file storage destination management table 630, the metadata location calculation process described at S808 is executed at S810 to extract such file paths that “a” is shown as the DB to which data belongs.

Then, the migration program 2145 divides the unreadable file list created at S810 according to file systems, and performs sorting in access-date-and-time order with the latest at the top, in each of the divided lists (S811).

Since each of the divided lists corresponds to an unreadable file list for each job unit, the migration program 2145 transmits each of the created lists to the client computer 10 of the administrator of each job so that the list can be displayed on the display screen of the client computer 10 as an available metadata checking result (S812).

### <Scene of Application of the Present Invention>

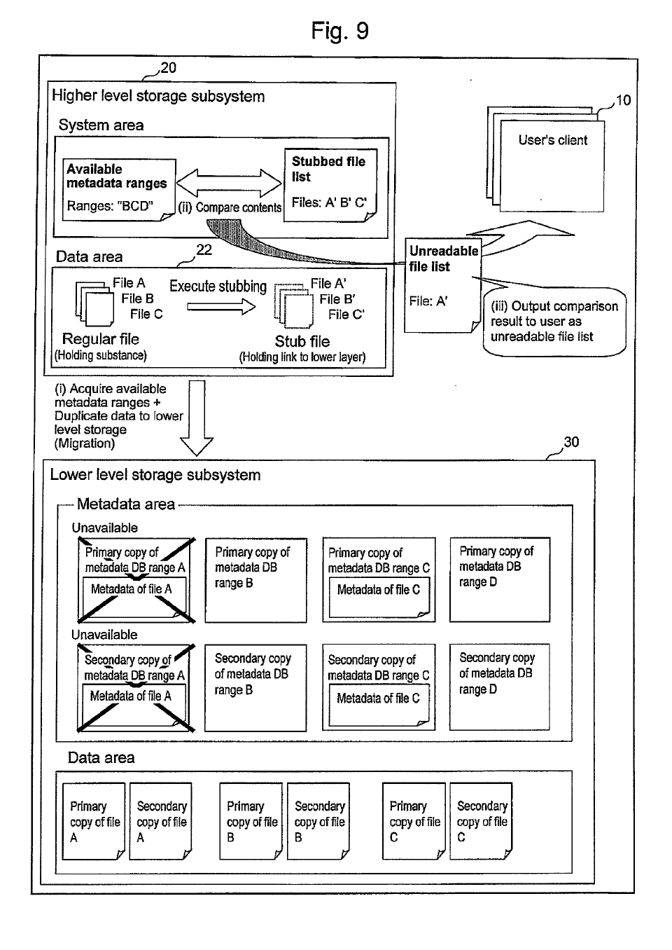

FIGS. 9 to 12 are diagrams for illustrating the basic function, applied function, variation of the present invention, and situations in which they are applied.

(1) Basic functions

(i) FIG. 9 is a diagram for illustrating the situation of application of a basic function 1 of the present invention. This basic function 1 is a function based on the processes by the flowcharts in FIGS. 7 and 8, which is a function performed until presentation of an unreadable file list (a function performed until presentation of the list generated at S810).

As described above, when data (for example, the files A to C) is written to the higher level storage subsystem 20 from the client computer 10, the data is once stored in a data area 22, and a duplicate of each data is migrated to the lower level storage subsystem 30. In the present invention, however, the higher level storage subsystem 20 acquires available metadata DB range information from the lower level storage subsystem 30 before performing migration. This is for the purpose of avoiding useless execution of the migration process and for the purpose of avoiding a situation of the load in the lower level storage subsystem 30 being excessive, as described above.

At a stage where a condition is satisfied, such as a condition that access has not occurred for a predetermined period, each file is stubbed in the higher level storage subsystem 20, and substantial data corresponding to generated stub data is deleted from the data area 22.

Here, consideration will be made on a case where, in the metadata area of the lower level storage subsystem 30, two nodes storing a part of metadata DB ranges (for example, information of a metadata DB range A) (one node stores a primary copy of the metadata DB range A, and the other stores a secondary copy of the metadata DB range A) go down at the same time. In this case, available metadata DB range information acquired by the higher level storage subsystem 20 shows that the metadata DB range A is lost or damaged and is unavailable. Then, this available metadata DB range information and a stubbed file list are compared to create an unreadable file list. This unreadable file list is transmitted to the client computer 10, and the user can know which file is unreadable due to loss or damage of metadata (metadata corresponding to data) in the lower level storage subsystem 30.

The higher level storage subsystem 20 manages file systems to which files belong, respectively (see FIG. 6D). This file system to which file belongs is set, for example, to manage files for each job. It is also possible to compare the generated unreadable file list and the file systems (jobs) to which files belong, identify such a job that is affected by loss or damage of metadata (complete loss or damage of a part of ranges) in the lower level storage subsystem 30 and notify the user (administrator) thereof. The user who has received the notification can take measures such as inhibiting reading of a corresponding file and writing the same data to the hierarchical storage system 1 again, and immediately restoring a failed node in the lower level storage subsystem 30.

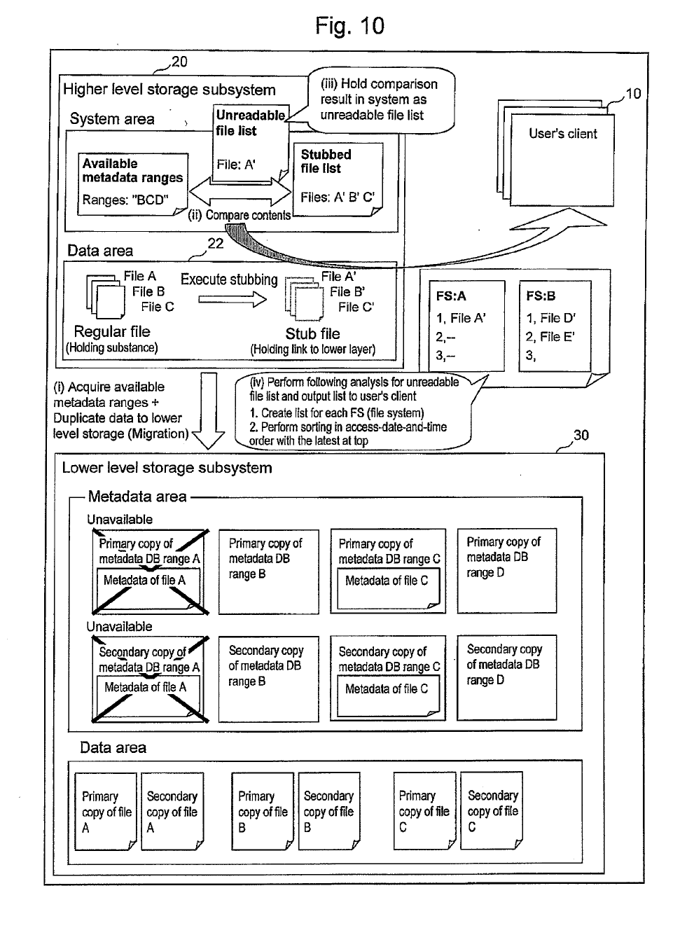

(ii) FIG. 10 is a diagram for illustrating a basic function 2 of presenting an unreadable file list for each job unit. The basic function 2 relates to a process of processing and presenting the list generated at S810 in FIGS. 8 at S811 and S812. In the basic function 2, when the unreadable file list is presented to the client computer 10, the table for data analysis 640 (FIG. 6D) is referred to, and files included in unavailable metadata DB ranges are sorted with respect to file systems created for job units, respectively. Thereby, an unreadable file list for each file system is generated. Then, files included in the list for each file system are sorted in access-date-and-time order with the latest at the top.

Thus, since information about unreadable files is presented for each job unit, the user (administrator) of each job can know how much the job he manages is affected.

(2) Applied function: access control in the higher level storage subsystem 20

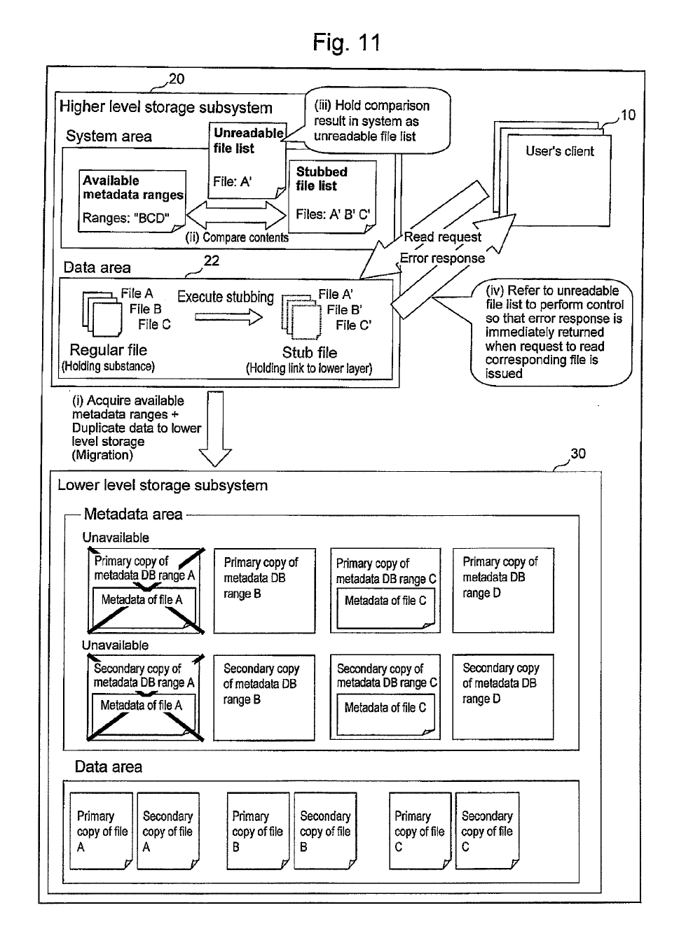

FIG. 11 is a diagram for illustrating an applied function of the present invention. The applied function is a function of controlling access from the client computer 10 using an unreadable file list generated by the above basic function. A process of generating an unreadable file list is similar to the cases of FIGS. 9 and 10.

Even if the user (administrator) acquires an unreadable file list by the basic function, he cannot take measures immediately. Each user attempts to access a necessary file from the client computer 10 before the administrator takes measures. In this case, since access to the lower level storage subsystem 30 is executed, it takes much time before access to a file involved in loss or damage of metadata is processed and it becomes clear that access is impossible due to the loss or damage of the metadata, as described before. It is difficult for the administrator to suppress such access requests from the users.

Therefore, in the applied function, when receiving an access request from each user, the higher level storage subsystem 20 compares an unreadable file list and a file corresponding to the access request, and, if the file is included in the list, notifies the access request transmission source client computer that the file is unreadable without transmitting the access request to the lower level storage subsystem 30.

As described above, according to the applied function, it is not necessary to process each of access requests of the users in the lower level storage subsystem 30, and, accordingly, it is possible to improve the efficiency of processing of an access request and reduce the processing load in the system.

(3) Variation

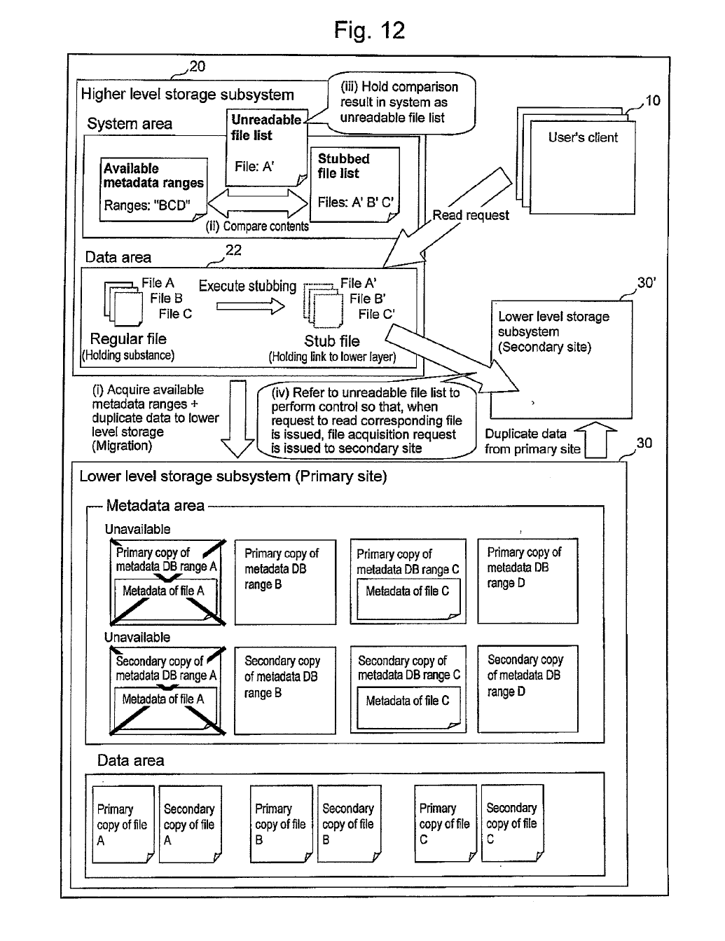

FIG. 12 is a diagram for illustrating a variation of the embodiment of the present invention. The variation provides a configuration in which the lower level storage subsystem 30 is doubled to improve fault tolerance. A process of generating an unreadable file list is similar to the cases of FIGS. 9 and 10.

As shown in FIG. 12, the lower level system is composed of a lower level storage subsystem 30 (primary site) and a lower level storage subsystem 30′ (secondary site) to be doubled. The doubling of the lower level system is realized by further migrating a duplicate of data migrated to the primary site 30, to the secondary site 30′ at an appropriate timing. Therefore, the contents of data stored in the primary site 30 and those in the secondary site 30′ are not usually correspond to each other completely (a timing at which they completely correspond to each other also exists), and the secondary site 30′ can be said to be a storage sub-system that stores at least a part of data of the primary site 30.

Here, a case is assumed where metadata in a part of ranges becomes completely unreadable in the lower level storage subsystem (primary site) 30 during system operation. In this case, as described above, an unreadable file list is generated on the basis of available metadata DB range information, and the higher level storage subsystem 20 holds this list for reference.

When a file access request is issued from the client computer 10, the higher level storage subsystem 20 judges whether a target file is included in an unreadable file list. When judging that the file is an unreadable file, the higher level storage subsystem 20 judges that the node in the primary site 30 that stores the target file has failed, and transmits the file access request not to the primary site 30 but to the secondary site 30′.

The secondary site 30′ which has received the file access request transmits the target file to the higher level storage subsystem 20.

Since a process of transferring a request to access a file included in an unreadable file list to the secondary site 30′ is executed in the higher level storage subsystem 20 as described above, it is possible to, even if metadata cannot be read in the primary site 30 due to a failure of a node, acquire a desired file.

(4) Conclusion

(i) In the embodiment of the present invention, a higher level storage subsystem manages multiple stub files. Substantial data corresponding to the stub files exist in a lower level storage subsystem. The lower level storage subsystem manages metadata (metadata corresponding to data, spatially corresponding metadata) indicative of correspondence relationships between multiple files in a virtual space and multiple real files in a substantial space corresponding to the multiple stub files, respectively. The higher level storage subsystem acquires available metadata range information indicative of availability and unavailability of metadata, from the lower level storage subsystem. Then, on the basis of the available metadata range information, an inaccessible file in a state that reading of substantial data in accordance with a stub file is unavailable is identified. Information about this inaccessible file is used for file management. For example, the inaccessible file information is transmitted to a client computer to notify a user thereof. Thereby, it is possible to call attention to refrain from accessing a corresponding file, and it is also possible to restore a failed node in the lower level storage subsystem and take measures for repairing loss or damage of metadata. By acquiring the inaccessible file information, the higher level storage subsystem can immediately identify a file that is inaccessible due to loss or damage of metadata. Therefore, processing time required to determine inaccessibility to substantial data can be shortened, and the efficiency of file management can be improved.

An inaccessible file is identified by applying a predetermined hash function (for example, a hash code method of Java (R)) to a file path of a stub file and dividing a result of the application by the number of available metadata ranges to identify a range to which metadata for acquiring a substantial file corresponding to the stub file belongs, and judging whether the metadata is available or unavailable.

The higher level storage subsystem writes a target file into a storage area in response to a file write request from the client computer and performs migration to the lower level storage subsystem at a predetermined timing. In the present invention, however, available ranges of metadata are confirmed as preprocessing before the migration process. That is, the higher level storage subsystem acquires available metadata range information from the lower level storage subsystem in response to the file write request. Then, if this available metadata range information includes information about unavailable metadata ranges, execution of the process of migrating the writing target file to the storage subsystem is inhibited. By doing so, it is possible to avoid useless execution of the migration process. If, in the lower level storage subsystem, a larger number of requests are received from the upper side attempting the migration process when only a smaller number of nodes than the total number of nodes are operating, there is a risk that the whole system goes down due to the process. According to the feature, such a risk can be avoided. If receiving information indicative of that some node is down, from the lower level storage subsystem, the higher level storage subsystem may acquire available metadata range information from the lower level storage subsystem.

In response to a file read request from the client computer, the higher level storage subsystem judges whether a file identified by the file read request is readable, by referring to inaccessible file information. If the file is judged to be unreadable, the higher level storage subsystem transmits an error response to the client computer without transferring the file read request to the lower level storage subsystem. By doing so, it is possible to, in the lower level storage subsystem, prevent useless execution of access to an inaccessible file, and, therefore, it is possible reduce the load in the system and perform file management efficiently.

Furthermore, the higher level storage subsystem manages multiple files, classifying them according to multiple file systems (job units). In this case, the higher level storage subsystem transmits inaccessible file information to the client computer, classifying the information according to the file systems (jobs). At this time, information for each job may be presented being sorted according to access date and time. By doing so, the user can immediately know such a job that is affected by loss or damage of metadata.

As another embodiment (variation), the lower level storage subsystem may be doubled. In this case, if it is judged that a file corresponding to a file access request from a client computer is an inaccessible file, the higher level storage subsystem does not transfer the file access request to a lower level primary site but transfers it to a lower level secondary site to acquire a file corresponding to the file access request. By doing so, it becomes possible to acquire a desired file efficiently.

(ii) All the functions described herein including the aforementioned basic function, the applied function and the function of the variation can be appropriately combined and used. Therefore, it should be noted that the functions are not mutually exclusive.

(iii) The present invention can be realized by a program code of software that realizes the functions of the embodiments, as described above. In this case, a storage medium in which the program code is recorded is provided for a system or an apparatus, and the computer (or the CPU or the MPU) of the system or the apparatus reads the program code stored in the storage medium. In this case, the program code itself read from the storage medium realizes the functions of the embodiments described before, and the program code itself and the storage medium storing it constitute the present invention. As the storage medium for providing the program code, for example, a flexible disk, CD-ROM, DVD-ROM, hard disk, optical disk, magneto-optical disk, CD-R, magnetic tape, non-volatile memory card, ROM and the like are used.

It is also possible for an OS (operating system) or the like operating on a computer to perform all or a part of an actual process on the basis of an instruction of a program code so that the functions of the embodiments described before are realized by the process. Furthermore, it is also possible for the CPU or the like of the computer to perform all or a part of an actual process on the basis of an instruction of the program code after the program code read from the storage medium is written to a memory on the computer so that the functions of the embodiments described before are realized by the process.

Furthermore, it is also possible to, by distributing the program code of the software for realizing the functions of the embodiments via a network, store it into storage means such as a hard disk and a memory of a system or an apparatus, or a storage medium such as a CD-RW and a CD-R so that the computer (or the CPU or the MPU) of the system or the apparatus reads and executes the program code stored in the storage means or the storage medium when it is used.

Lastly, it is necessary to understand that the processes and techniques stated herein are essentially not related to any particular apparatus and can be implemented by any appropriate combination of components. Furthermore, various types of general-purpose devices can be used in accordance with instructions described herein. It may be known that it is useful to construct a dedicated apparatus to execute the steps of the method described herein. Various inventions can be formed by appropriate combination of the multiple components disclosed in the embodiments. For example, some components may be deleted from all the components shown in the embodiments. Furthermore, components in different embodiments may be appropriately combined. The present invention has been described in relation to specific examples. The specific examples, however, are not for limitation but for description, from every point of view. One skilled in the art will understand that there are a lot of combinations of hardware, software and firmware appropriate for practicing the present invention. For example, the described software can be implemented by a wide range of programs or script languages, such as assembler, C/C++, Perl, Shell, PHP and Java (R).

Furthermore, only control lines and information lines considered to be necessary for description are shown in the embodiments described above, and all control lines and information lines are not necessarily shown from the viewpoint of a product. All the components may be mutually connected.

In addition, to one having ordinary knowledge in the art, other implementations of the present invention will be apparent from consideration of the specification and embodiments of the present invention disclosed herein. The described various aspects and/or components of the embodiments can be used singly or in any combination in a computerized storage system having a function of managing data. The specification and the specific examples are merely typical, and the scope and spirit of the present invention are shown by the claims below.

### REFERENCE SIGNS LIST

1 hierarchical storage system

10 client computer

20 higher level storage subsystem

21 type I NAS apparatus

22 storage apparatus 1

30 lower level storage subsystem

31 type II NAS apparatus

32 storage apparatus 2

33 FC switch

40 LAN switch

1. A hierarchical storage system comprising a first storage subsystem receiving an I/O request from a client computer and processing the I/O request and a second storage subsystem composed of multiple nodes each of which has a storage apparatus, wherein
the second storage subsystem has a storage area for storing metadata indicative of correspondence relationships between multiple files in a virtual space and multiple substantial files in a substantial space corresponding to multiple stub files respectively, and the first storage subsystem comprises:
a storage area for storing multiple stub files corresponding to such multiple files that substantial files exist in the second storage subsystem; and
a processor acquiring available metadata range information indicative of available and unavailable ranges of the metadata from the second storage subsystem and identifying inaccessible files that are in a state that reading of the substantial data in accordance with the stub file is impossible, on the basis of the available metadata range information to manage information about the inaccessible files.

2. The hierarchical storage system according to claim 1, wherein in response to a file write request from the client computer, the processor acquires the available metadata range information from the second storage subsystem, and, if the available metadata range information includes unavailable metadata range information, inhibits execution of a process of migrating a writing target file to the storage subsystem.

3. The hierarchical storage system according to claim 1, wherein in response to a file read request from the client computer, the processor refers to the inaccessible file information to judge whether a file identified by the file read request is readable, and, if the file is judged to be unreadable, transmits an error response to the client computer without transferring the file read request to the second storage subsystem.

4. The hierarchical storage system according to claim 1, wherein the processor identifies the inaccessible file by applying a predetermined hash function to a file path of the stub file and judging whether or not metadata for reading a substantial file corresponding to the stub file is included in the available or unavailable ranges of the metadata on the basis of a result of the application and the available metadata range information.

5. The hierarchical storage system according to claim 4, wherein the processor transmits the inaccessible file information to the client computer.

6. The hierarchical storage system according to claim 5, wherein the first storage subsystem manages multiple files, classifying the files in multiple file systems; and
the processor classifies the inaccessible file information according to the file systems to transmit the information to the client computer.

7. The hierarchical storage system according to claim 1, wherein the system is doubled with the second storage subsystem and a third storage subsystem having at least a part of information stored in the second storage system; and
if a file corresponding to a file access request from the client computer is an inaccessible file, the processor transfers the file access request to the third storage subsystem without transmitting the file access request to the second storage subsystem to acquire the file corresponding to the file access request, and transmits the file to the client computer.

8. The hierarchical storage system according to claim 1, wherein if receiving information indicative of that a node is down, from the second storage subsystem, the processor acquires the available metadata range information from the second storage subsystem.

9. A file management method in a hierarchical storage system comprising a first storage subsystem receiving an I/O request from a client computer and processing the I/O request and a second storage subsystem composed of multiple nodes each of which has a storage apparatus, wherein
the second storage subsystem manages metadata indicative of correspondence relationships between multiple files in a virtual space and multiple substantial files in a substantial space corresponding to multiple stub files, respectively;
the first storage subsystem manages multiple stub files corresponding to such multiple files that a substantial file exists in the second storage subsystem; and
the file management method comprising:
a processor of the first storage subsystem acquiring available metadata range information indicative of available and unavailable ranges of the metadata from the second storage subsystem; and
the processor identifying inaccessible files that are in a state that reading of the substantial data in accordance with the stub file is impossible, on the basis of the available metadata range information to manage information about the inaccessible files.

10. The file management method according to claim 9, further comprising:
in response to a file write request from the client computer, the processor acquiring the available metadata range information from the second storage subsystem;
if the available metadata range information includes unavailable metadata range information, the processor inhibiting execution of a process of migrating a writing target file to the storage subsystem.

11. The file management method according to claim 9, further comprising:
in response to a file read request from the client computer, the processor referring to the inaccessible file information to judge whether a file identified by the file read request is readable; and
if the identified file is judged to be unreadable, the processor transmitting an error response to the client computer without transferring the file read request to the second storage subsystem.

12. The file management method according to claim 9, wherein the processor identifies the inaccessible file by applying a predetermined hash function to a file path of the stub file and judging whether or not metadata for reading a substantial file corresponding to the stub file is included in the available or unavailable ranges of the metadata on the basis of a result of the application and the available metadata range information.

13. The file management method according to claim 12, further comprising:
the processor transmitting the inaccessible file information to the client computer.

14. The file management method according to claim 13, wherein
the first storage subsystem manages multiple files, classifying the files in multiple file systems; and
the processor classifies the inaccessible file information according to the file systems to transmit the information to the client computer.

15. The file management method according to claim 9, wherein
the hierarchical storage system is doubled with the second storage subsystem and a third storage subsystem having at least a part of information stored in the second storage system; and
the file management method further comprising:
if a file corresponding to a file access request from the client computer is an inaccessible file, the processor transferring the file access request to the third storage subsystem without transmitting the file access request to the second storage subsystem to acquire the file corresponding to the file access request; and
the processor transmitting the file acquired from the third storage subsystem to the client computer.
